(19) United States
(12) Patent Application Publication
(10) Pub. No.: US 2015/0029942 A1
(43) Pub. Date: Jan. 29, 2015

(54) PAIRING METHOD FOR ELECTRONIC DEVICE

(71) Applicant: HTC Corporation, Taoyuan County (TW)

(72) Inventors: Ming-Yu Chen, Taoyuan County (TW); Fu-Chiang Chou, Taoyuan County (TW)

(73) Assignee: HTC Corporation, Taoyuan County (TW)

(21) Appl. No.: 13/948,183

(22) Filed: Jul. 23, 2013

(51) Int. Cl. H04W 76/02; H04W 4/20

(52) U.S. Cl. CPC H04W 76/021; H04W 4/20
USPC 370/329

(57) ABSTRACT

A pairing method for electronic devices is provided and includes the following steps. First, an ordering information is received, in which the ordering information is produced by the user ordering a second electronic device on an online store via a first electronic device. A provider of the second electronic device records pairing information of the second electronic device. The provider of the second electronic device transmits the pairing information to the user's first electronic device via communication network. When the user receives the ordered second electronic device, the first electronic device makes a pair with the second electronic device automatically according to the pairing information, so as to establish a wireless connection between the first and second electronic devices.

### BACKGROUND

1. Field of the Invention

The invention is directed to an automatic pairing method and more particularly, to a method for automatically pairing electronic devices.

2. Description of Related Art

With the development of various types of electronic devices and the progress of various functions equipped therewith, the electronic devices have become more and more inseparable in people's life. A commonly used electronic device is, for example, a notebook computer (NB), a smart phone, a tablet computer, which is typically equipped with a communication interface, such that a user can perform data communication or data transmission with another peripheral device via the communication interface.

Wireless connection has to be established between a device owned by the user and another peripheral device via the communication interface in advance to the data communication or data transmission among various electronic devices. Generally, one of the steps is to turn on a wireless communication function (e.g. the function using the Bluetooth wireless technology or the Wireless fidelity (Wi-Fi) technology). Then, the user has to manually select a network or an electronic device to be connected to on his/her own device to start a pairing procedure. Thereafter, the user has to manually input a username or a pairing password for an identity authentication and pairing processes.

Based on the above, the user has to spend time on selecting the network or the electronic device to be connected to from a list and spend effort on manually inputting the username or the password. Once errors occur in any one of the steps of selecting the object to be connected to and inputting the username and the password, all the steps for establishing the wireless connection have to be repeated, and this leads to inconvenience of use. In addition, with more and more variety of the electronic devices, if multiple electronic devices in compliance with the same wireless communication technology exist within an effective transmission range, pairing errors would probably occur.

### SUMMARY

Accordingly, the present invention is directed to a pairing method for electronic devices, by which manually operation processes for a user to establish wireless connection between communication electronic devices may be simplified so as to improve convenience of use and avoid pairing errors.

The present invention is directed to a pairing method for electronic devices. The method includes providing a second electronic device to a user, and transmitting pairing information of the second electronic device to a first electronic device of the user via communication network, such that the first electronic device is automatically paired with the second electronic device according to the pairing information to establish wireless connection between the first electronic device and the second electronic device.

In an embodiment of the present invention, before the step of providing the second electronic device to the user, ordering information is received, wherein the ordering information is produced by the user ordering the second electronic device on an online store. Then, the pairing information is recorded and transmitted to the first electronic device of the user via network communication by a provider of the second electronic device. When the user receives the purchased second electronic device, the first electronic device is automatically paired with the second electronic device according to the received pairing information so as to establish the wireless connection between the first electronic device and the second electronic device.

In an embodiment of the present invention, the step of recording the pairing information of the second electronic device by the provider of the second electronic device includes scanning barcode information on the package of the second electronic device by the provider of the second electronic device using a scanning apparatus when the second electronic device is to be shipped and then, analyzing the barcode information to obtain and store the pairing information.

In an embodiment of the present invention, the barcode information is one of a one-dimensional bar code, a two-dimensional bar code and a three-dimensional bar cod.

In an embodiment of the present invention, the step of transmitting the pairing information to the first electronic device of the user via the communication network by the provider of the second electronic device includes transmitting the pairing information to the first electronic device of the user via Internet by the provider of the second electronic device.

In an embodiment of the present invention, the step of transmitting the pairing information of the second electronic device to the first electronic device of the user via the communication network by the provider of the second electronic device includes transmitting the pairing information to the first electronic device of the user through a short message service (SMS) or a multimedia message service (MMS).

In an embodiment of the present invention, after the step of transmitting the pairing information of the second electronic device to the first electronic device of the user via the communication network by the provider of the second electronic device, the method further includes reading and storing the pairing information by the first electronic device and writing the pairing information into a network setting via an application software.

In an embodiment of the present invention, the pairing information includes an identifier and a pairing password of the second electronic device.

In an embodiment of the present invention, if both the first electronic device and the second electronic device are in compliance with the Bluetooth wireless technology, the identifier is a media access control (MAC) address.

In an embodiment of the present invention, if both the first electronic device and the second electronic device are in compliance with the Wireless fidelity (Wi-Fi) technology, the identifier is a service set identifier (SSID).

To sum up, the pairing method for electronic device of the present invention has an advantage that a pairing relationship between the product to be shipped and an electronic device originally owned by a buyer is established according to the pairing settings for a vendor to process products before the product is shipped, such that the buyer may automatically pair the electronic devices to establish the wireless connection when receiving the electronic device shipped by the vendor. By doing so, manually operation processes for the user to establish the connection between the wireless communication devices may be simplified to improve convenience of use of the electronic devices.

In order to make the aforementioned and other features and advantages of the present invention more comprehensible, several embodiments accompanied with figures are described in detail below.

### BRIEF DESCRIPTION OF THE DRAWINGS

The accompanying drawings are included to provide a further understanding of the present invention, and are incorporated in and constitute a part of this specification. The drawings illustrate embodiments of the present invention and, together with the description, serve to explain the principles of the present invention.

FIG. 1 is a flowchart illustrating a paring method for electronic devices according to an embodiment of the present invention.

FIG. 2 is a timing flowchart illustrating a paring method for electronic devices according to another embodiment of the present invention.

FIG. 3 is a simplified schematic diagram illustrating an application scenario according to yet another embodiment of the present invention.

### DESCRIPTION OF EMBODIMENTS

The present invention is directed to a paring method for electronic devices, by which a provider processes pairing settings for goods when a user purchases a new wireless communication device, so that the newly purchased wireless communication device is automatically paired with an originally owned wireless communication device of the user when receiving the wireless communication device shipped by the provider. Thereby, manually operation processes for the user to establish the connection between the wireless communication devices may be dramatically simplified to improve convenience of use. In order to make the content of the present invention clearer, the following embodiments are illustrated as examples that can be truly implemented by the present invention.

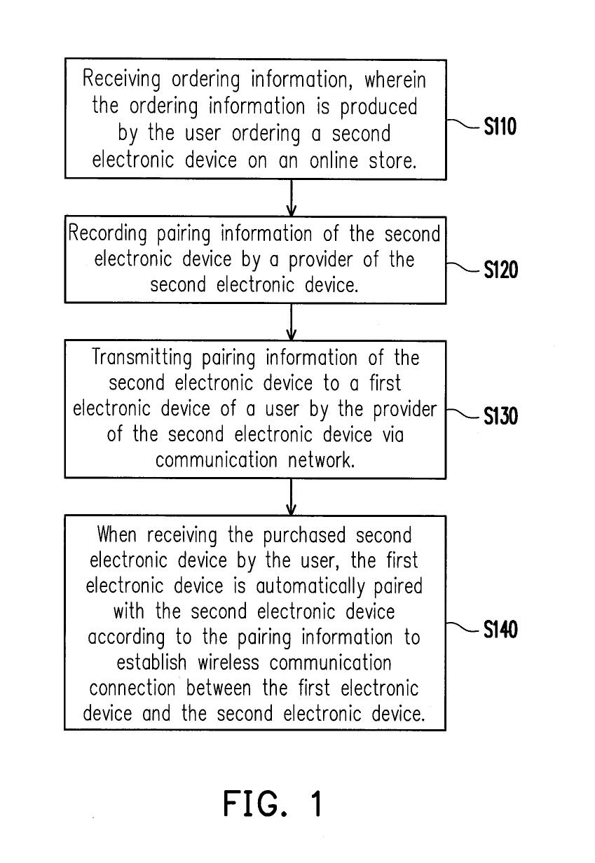

FIG. 1 is a flowchart illustrating a paring method for electronic devices according to an embodiment of the present invention. Description in connection with the method will be made with reference to FIG. 1 as follows.

First, in step S110, ordering information is received. The ordering information is produced by the user ordering a second electronic device on an online store. For instance, the user may order on the online store by using an originally owned first electronic device. In the present embodiment, the first electronic device may be an electronic device having a function for linking to Internet and complying with wireless communication technologies, such as a personal digital assistant (PDA), a PDA mobile phone, a smart phone, a touch mobile phone, a tablet computer, a notebook computer or an Ultrabook computer, but the present invention is not limited thereto.

Since the rise of Internet, Internet has become a brand new marketing tool and trading platform. Many business behaviors with transactions via Internet have gradually become widely used. An online store, which is also called an online shopping website or an e-shop, sells goods or services on Internet and provides users with an online ordering function. Accordingly, a user may link to the online store for browsing and selecting a product by using a network connection function of the first electronic device. The ordering information as referred to herein includes, for example, the order, the payment, the user's personal information and so on, which is related to the information that is produced by ordering the second electronic device on the online store by the user.

In the present embodiment, the second electronic device is in compliance with the same wireless communication technology as the first electronic device. For instance, if the first electronic device is in compliance with the Bluetooth wireless communication technology, the second electronic device may be, for example, a PDA, a PDA mobile phone, a smart phone, a touch mobile phone, a tablet computer, a notebook computer or an Ultrabook computer complying with the Bluetooth wireless technology. Alternatively, the second electronic device may also be a peripheral accessory, such as a Bluetooth headset, a Bluetooth mouse or a Bluetooth keyboard. In another example, if the first electronic device is in compliance with the Wireless Fidelity (Wi-Fi) technology, the second electronic device may be an electronic product in compliance with the Wi-Fi peer-to-peer connection technology.

Then, in step S120, the provider of the second electronic device records pairing information of the second electronic device. The pairing information at least includes an identifier and a pairing password of the second electronic device. Besides, the pairing information may also include a manufacturer name, a device model and so on, and the present invention is not intent to limit the content of the pairing information. In detail, the provider of the second electronic device may be a manufacturer of the second electronic device. The manufacturer of the second electronic device presets the identifier and the pairing password and stores the pairing information when shipping the second electronic device. In an embodiment, the manufacturer records the pairing information in a bar code format which is printed on the packing case of the second electronic device. When the shipment of the second electronic device is confirmed, the barcode information on the package of the second electronic device is scanned by using a scanning apparatus, or an image containing the barcode information is captured by using an image capture device. Afterward, the barcode information is analyzed so as to be decoded and converted into the pairing information. The barcode information may be any one of a one-dimensional bar code, a two-dimensional bar code and a three-dimensional bar code or a combination thereof, but the present invention is not limited thereto.

If the second electronic device is in compliance with the Bluetooth wireless technology, the identifier of the second electronic device is a media access control (MAC) address. If the second electronic device is in compliance with the Wireless Fidelity (Wi-Fi) technology, such as a Wi-Fi access point (AP), the identifier of the second electronic device is a service set identifier (SSID). An SSID is a name or an identifier in a wireless network, which may be a string composed of any alphabets (including uppercase and lowercase letters) and numeric. A manufacturer of the Wi-Fi AP factory presets the SSID when shipping.

Thereafter, in step S130, the provider of the second electronic device transmits the pairing information to the first electronic device of the user via communication network. In an embodiment, the provider of the second electronic device may transmit the pairing information to the first electronic device of the user via Internet. In another embodiment, the provider of the second electronic device may transmit the pairing information to the first electronic device of the user through a short message service (SMS) or a multimedia message service (MMS).

It is to be mentioned that the time for transmitting the pairing information to the first electronic device of the user via the communication network is not limited to before or after the shipment. In other words, after the pairing information of the second electronic device is obtained, any time for the pairing information being transmitted to the first electronic device of the user before the second electronic device is received by the user is applicable.

Finally, in step S140, when the user receives the purchased second electronic device, the first electronic device is automatically paired with the second electronic device according to the pairing information so as to establish wireless connection between the first electronic device and the second electronic device. In detail, the wireless connection may include peer-to-peer wireless communication, which is, for example, Ad Hoc communication mode, Bluetooth pairing, the connection between the Wi-Fi device and the Wi-Fi AP and so on, but the present invention is not limited thereto. According to different types of communication networks, the wireless connection referred to in the present embodiment may be classified as, for example, a wireless personal area network (WPAN) or a wireless local area network (WLAN). The WPAN establishes connection based on, for example, the IEEE 802.15 standard, while the WLAN establish connection based on, for example, the IEEE 802.11 standard.

When the user receives the purchased second electronic device, the first electronic device may be wireless connected with the second electronic device by way of the pairing relationship pre-established according to the pairing information, such that the user does not have to manually perform the pairing settings. Since the first electronic device already has the unique identifier of the second electronic device, both the first and the second electronic devices do not have to broadcast their own device information. By doing so, pairing errors occurring when multiple users simultaneously use the same wireless communication technology (e.g. Bluetooth pairing technology) can be avoided.

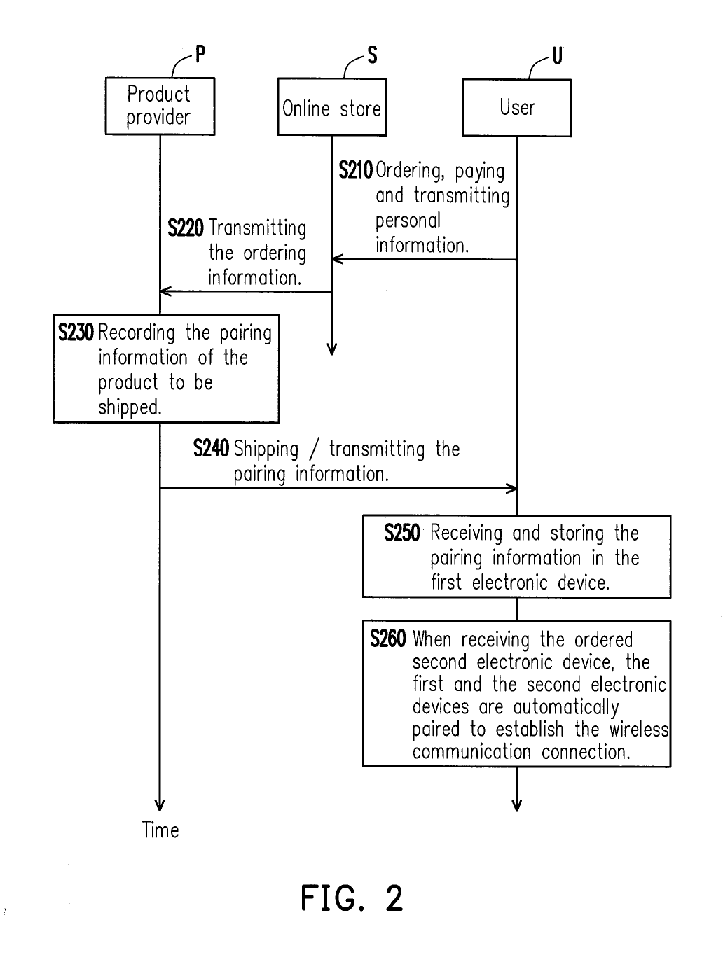

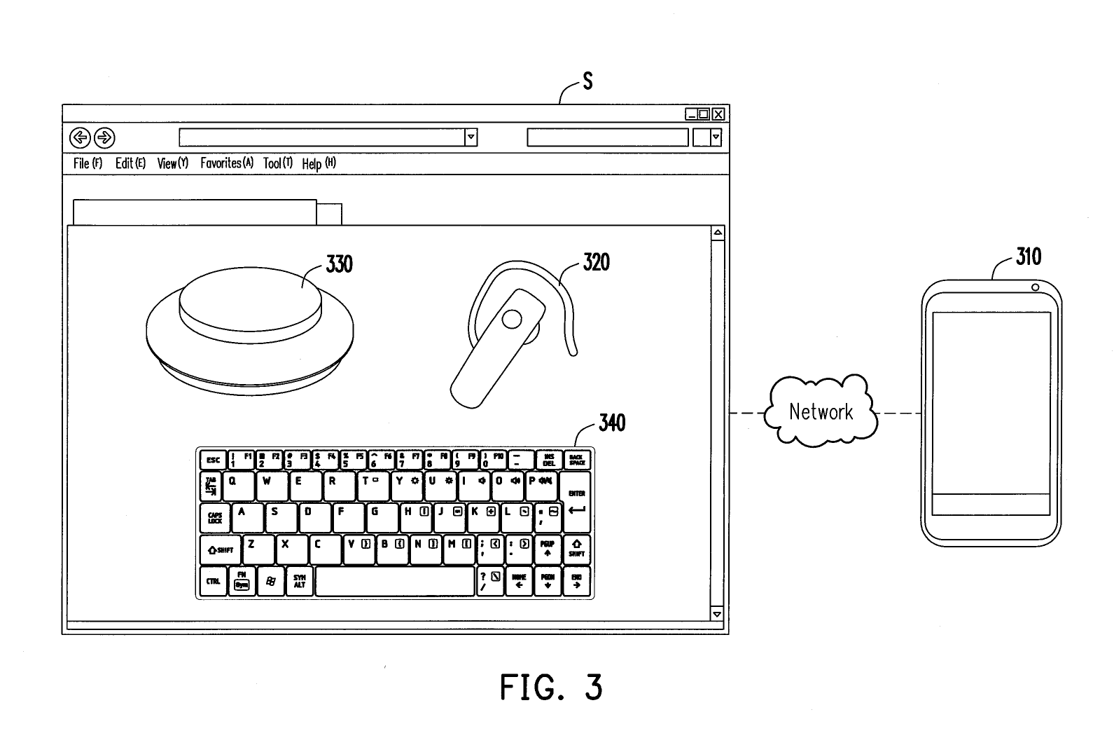

In order to further describe the process of the pairing method of the present invention in detail, an application embodiment will be illustrated as an example with reference to the timing flowchart of FIG. 2. FIG. 2 is a timing flowchart illustrating a paring method for electronic devices according to another embodiment of the present invention. FIG. 3 is a simplified schematic diagram illustrating an application scenario according to yet another embodiment of the present invention. Description will be made with reference to FIG. 2 and FIG. 3 as follows.

First, in step S210, a user U uses, for example, a smart phone 310 in compliance with the Bluetooth wireless technology and links to an online store S by utilizing a network connection function of the smart phone 310. After confirming a second electronic device that the user U wants to order, he/she makes a payment and transmits information, such as personal contact information and so on, to the online store S. It is to be mentioned that the user U may order one or more electronic devices (e.g. a Bluetooth headset 320, a Bluetooth speaker or a Bluetooth keyboard) at the same time, but the present invention is not limited thereto.

The online store S may be only a trading platform, instead of a vendor doing shipment. Thus, in step S220, the online store S has to further transmit the ordering information of the user U to a product provider P (i.e., a manufacturer of the second electronic device). In an embodiment, the online store S may also link to the official website of the product provider P and then transmits the ordering information to the official website of the product provider P. In another embodiment, the online store S may also transmit the ordering information of the user U by way of email to an email address of the product provider P. In other embodiments, the ordering information may also be transmitted by way of facsimile, and the present invention is not intent to limit the way to transmit the ordering information to the provider.

In step S230, after confirming the product model and quantity as ordered by the user U, the product provider P may record pairing information of the second electronic device that is confirmed to be shipped to the user U. The pairing information includes, for example, an identifier, a pairing password, a manufacturer name, a device model or any other information of the second electronic device. In the present embodiment, if it is confirmed that the second electronic device purchased by the user U is the Bluetooth headset 320, the identifier is a MAC address, and the pairing password, which is also referred to as a personal identification number (PIN), has a default value of 0000.

Then, in step S240, the product provider P directly transmits the pairing information to the user U and ships the Bluetooth headset 320 to a recipient address of the user U. Therein, the product provider P may transmit the pairing information to the smart phone 310 of the user U by way of the SMS or MMS using, for example, a mobile phone number of the smart phone 310 of the user U that is recorded in the ordering information.

Thereafter, in step S250, after a SMS or MMS message containing the ordering information is received by the smart phone 310 of the user U, the smart phone 310 reads and then store the pairing information contained in the SMS or MMS message via an application software. The application software may also directly write the identifier (i.e., the MAC address) and the pairing password into a network setting of the smart phone 310 so as to pre-establish a pairing relationship.

Finally, in step S260, when the user U received the purchased Bluetooth headset (i.e., the second electronic device) 320, as long as both the smart phone 310 and the Bluetooth headset 320 turns the Bluetooth function, the smart phone 310 is automatically paired with the Bluetooth headset 320 so as to establish wireless connection. Thus, the user does not have to select the pairing device and input the pairing password manually, such that steps for the user to perform the pairing process may be dramatically simplified.

Based on the above, in the present invention, the pairing settings are pre-processed by the vendor and the pairing information is transmitted to the electronic device of the buyer, such that the pairing relationship may be pre-established by the buyer. The originally owned electronic device is automatically paired with the newly purchased electronic device so as to establish the wireless connection therebetween when receiving the electronic device shipped from the vendor. By this way, the steps for the user to manually establish the connection between the wireless communication devices can be dramatically simplified so as to improve the convenience of use. Besides, when multiple users simultaneously use the same wireless communication technology, the pairing errors can also be avoided.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A paring method for electronic devices, comprising:
providing a second electronic device to a user; and
transmitting pairing information of the second electronic device to a first electronic device of the user via a communication network, such that the first electronic device is automatically paired with the second electronic device according to the pairing information to establish a wireless connection between the first electronic device and the second electronic device.

2. The method according to claim 1, wherein before the step of providing the second electronic device to the user, the method further comprises:
receiving ordering information, wherein the ordering information is produced by the user ordering the second electronic device on an online store; and
recording the pairing information of the second electronic device.

3. The method according to claim 2, wherein the step of recording the pairing information of the second electronic device comprises:
scanning barcode information on a package of the second electronic device by using a scanning apparatus; and
analyzing the barcode information to obtain and store the pairing information.

4. The method according to claim 3, wherein the barcode information is one of a one-dimensional bar code, a two-dimensional bar code and a three-dimensional bar code.

5. The method according to claim 1, wherein the communication network comprises Internet.

6. The method according to claim 1, wherein the step of transmitting the pairing information of the second electronic device to the first electronic device of the user via the communication network comprises:
transmitting the pairing information to the first electronic device of the user through a short message service (SMS) or a multimedia message service (MMS).

7. The method according to claim 1, wherein after the step of transmitting the pairing information of the second electronic device to the first electronic device of the user via the communication network, the method further comprises:
reading and storing the pairing information by the first electronic device via an application software; and
writing the pairing information into a network setting by the application software of the first electronic device.

8. The method according to claim 1, wherein the pairing information comprises an identifier and a pairing password of the second electronic device.

9. The method according to claim 8, wherein the first electronic device and the second electronic device is in compliance with the Bluetooth wireless communication technology, and the identifier is a media access control (MAC) address.

10. The method according to claim 8, wherein the first electronic device and the second electronic device are in compliance with the Wireless Fidelity (Wi-Fi) technology, and the identifier is a service set identifier (SSID).
